(19) United States
(12) Patent Application Publication
(10) Pub. No.: US 2006/0212180 A1
(43) Pub. Date: Sep. 21, 2006

(54) Method for managing in-flight refuelling of a fleet of aircraft

(76) Inventor: Fabrice T P Saffre, Ipswich (GB)

Correspondence Address: NIXON & VANDERHYE, PC, 901 NORTH GLEBE ROAD, 11TH FLOOR, ARLINGTON, VA, 22203, US

(21) Appl. No.: 10/550,204

(22) PCT Filed: Mar. 12, 2004
(86) PCT No.: PCT/GB04/01056

§ 371 Date: Sep. 21, 2005

(30) Foreign Application Priority Data
Mar. 27, 2003 (GB) 03071388

(51) Int. Cl. G06F 19/00

(52) U.S. Cl. 701/3; 701/16

(57) ABSTRACT

Many types of vehicle disturb the environment behind them as they proceed. As a result, a delay between two successive vehicles has to be maintained to avoid a situation where following vehicles are adversely affected by the disturbed environment caused by leading vehicles. Previously, sequencing has been carried out on a “first come, first served” basis but this is not satisfactory. A method of sequencing a plurality of vehicles is disclosed, wherein each candidate vehicle in said plurality of candidate vehicles is a candidate to be allocated the next place in a sequence, said method comprising the steps of: (i) receiving information pertaining to one of said candidate vehicles; (ii) calculating a value to be attributed to said candidate vehicle on the basis of said received information and information received from the candidate vehicle most recently allocated a place in said sequence; (iii) repeating steps (i) and (ii) for each of said candidate vehicles; (iv) selecting one of said candidate vehicles based on said attributed values; and (v) allocating said selected candidate vehicle the next place in said sequence.

This invention relates to a method of sequencing vehicles. It has particular application for establishing the landing sequence of aircraft.

A phenomenon known as ‘wake turbulence’ is caused by wake vortices, which form whenever an aircraft wing is producing lift. The pressure differential between the top and bottom surfaces of the wing triggers the roll-up of the airflow aft of the wing resulting in swirling masses of air trailing downstream of the wing tips. The intensity or strength of the vortices are primarily a function of the aircraft weight with the strongest vortices being produced by heavy aircraft.

Flying into the vortices can cause imbalance in following aircraft (possibly causing the following aircraft to crash) especially if the mass of the following aircraft is too small or the intensity of the vortices is too great. As a result, a delay between two successive aircraft landings has to be maintained to avoid this potentially hazardous situation. This delay has to be extended proportionally to the mass ratio of the leading and following aircraft.

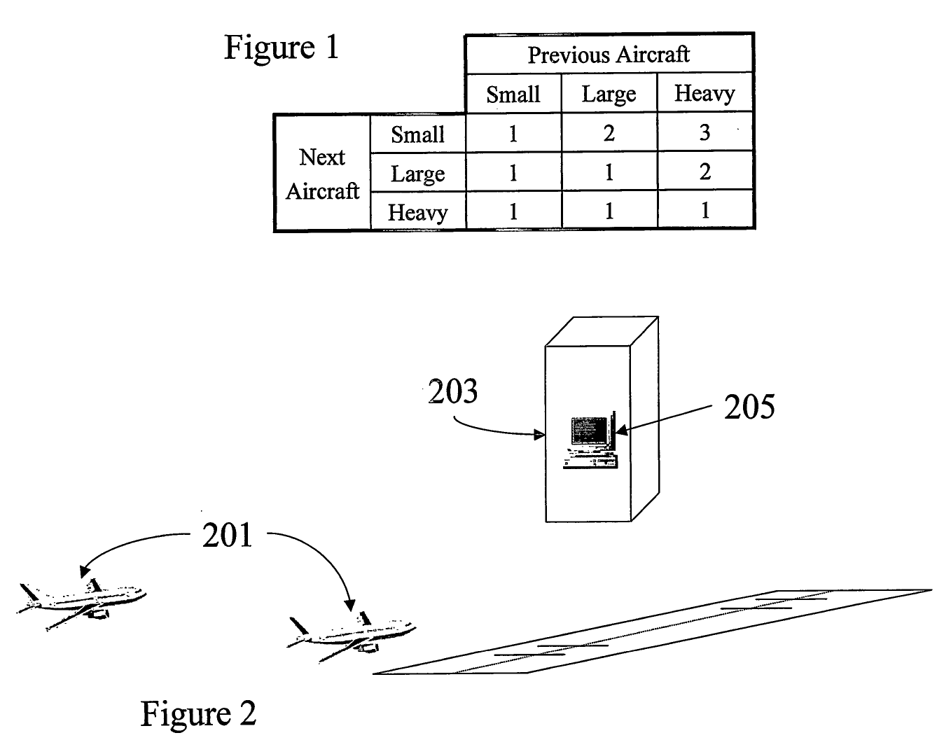

Assuming that there are three categories of aircraft (“heavy”, “large” and “small”) and that the safe delay between them is an incremental function of their relative size, FIG. 1 shows a table summarising the delays (in time units, e.g. minutes) that must be maintained between successive landings. If all aircraft belonged to just one category then the delay would always be minimal. The delay would also be minimal if the arriving air traffic was grouped into three sets with all “small” aircraft landing first, followed by all “large” aircraft and followed finally by all “heavy” aircraft. It is, of course, highly unlikely that timetable requirements would allow the organisation of air traffic into such a perfectly ordered sequence. In fact, aircraft belonging to all three categories follow each other at random and a problem facing air traffic controllers is choosing the aircraft which should be allowed to land next.

Two systems currently used by air traffic controllers to sequence incoming aircraft and to ensure landing aircraft are safely separated are Traffic Management Advisor (TMA) and Final Approach Spacing Tool (FAST) both developed by the National Aeronautics and Space Administration (NASA) Ames Research Centre, Moffett Field, Calif. 94035, USA.

Both these systems sequence incoming aircraft on a first come, first served (FCFS) basis where the first incoming aircraft to contact air traffic control (ATC) (with a request to land) on entering the terminal area (a term used to describe airspace in which air traffic control service is provided to aircraft arriving and departing an airfield) is allocated a landing slot first and placed at the start of the sequence. Subsequent, incoming aircraft are placed in the sequence in the order in which they enter the terminal area and contact ATC. Appropriate spacing is applied between sequenced aircraft to comply with safety constraints. It has been found, however, that sequencing aircraft on a FCFS basis leads to a less than optimal landing rate which leads to increased delays for arriving aircraft as they are forced to wait in the terminal area (usually in a waiting/holding stack) to be allocated a landing slot. This in turn leads to a reduction in quality of service provided by airlines and also to a increase in fuel consumption for the waiting aircraft.

According to a first aspect of the present invention there is provided a method of sequencing a plurality of candidate vehicles, wherein each candidate vehicle in said plurality of candidate vehicles is a candidate to be allocated the next place in a sequence, said method comprising the steps of:

(i) receiving information pertaining to one of said candidate vehicles;

(ii) calculating a value to be attributed to said candidate vehicle on the basis of said received information and information received from the candidate vehicle most recently allocated a place in said sequence;

(iii) repeating steps (i) and (ii) for each of said candidate vehicles;

(iv) selecting one of said candidate vehicles based on said attributed values; and

(v) allocating said selected candidate vehicle the next place in said sequence.

Preferably the plurality of candidate vehicles comprises a plurality of candidate aircraft and the sequence is the landing sequence. By using information pertaining to candidate aircraft information from the aircraft most recently allocated a place in the sequence, a value can be calculated for each of the candidate aircraft and one of the candidate aircraft can be selected and allocated the next place in the sequence. The sequence of aircraft thus generated is more optimal than sequences otherwise generated, for example on a “first come, first served” basis.

Preferably, said received information is received from the candidate vehicle to which said received information pertains. In this way, it is more than likely that the received information will be up-to-date.

Preferably, said value is representative of the spacing that would have to be maintained between the candidate vehicle and the candidate vehicle most recently allocated a place in said sequence if said candidate vehicle were allocated the next place in the sequence. In this way, the average interval between successive vehicles is reduced.

Preferably, said value is representative of the delay that would be experienced by said candidate vehicle if said candidate vehicle were allocated the next place in the sequence. In this way, the average delay experienced by the candidate vehicles is reduced.

According to a second aspect of the present invention, there is provided a method of operating a sequencing apparatus to sequence a plurality of candidate vehicles, wherein each candidate vehicle in said plurality of candidate vehicles is a candidate to be allocated the next place in a sequence, said method comprising the steps of:

(i) receiving information pertaining to one of said candidate vehicles;

(ii) calculating a value to be attributed to said candidate vehicle on the basis of said received information and information received from the candidate vehicle most recently allocated a place in said sequence;

(iii) repeating steps (i) and (ii) for each of said candidate vehicles;

(iv) selecting one of said candidate vehicles based on said attributed values; and

(v) allocating said selected candidate vehicle the next place in said sequence.

Preferably, said method further comprises the step of:

(vi) sending details of the next place in said sequence to said selected candidate vehicle.

According to a third aspect of the present invention there is provided sequencing apparatus arranged in operation to sequence a plurality of candidate vehicles, wherein each candidate vehicle in said plurality of candidate vehicles is a candidate to be allocated the next place in a sequence, said data processing apparatus comprising:
receiving means for receiving information pertaining to one of said candidate vehicles;
calculating means for calculating a value to be attributed to said candidate vehicles on the basis of said received information and information received from the candidate vehicle most recently allocated a place in said sequence;
selecting means for selecting one of said candidate vehicles based on said attributed values; and
allocating means for allocating said selected candidate vehicle the next place in said sequence.

According to a fourth aspect of the present invention there is provided sequencing apparatus arranged in operation to sequence a plurality of candidate vehicles, wherein each candidate vehicle in said plurality of candidate vehicles is a candidate to be allocated the next place in a sequence, said data processing apparatus comprising:
a receiver arranged in operation to receive information pertaining to one of said candidate vehicles;
a calculator arranged in operation to calculate a value to be attributed to said candidate vehicles on the basis of said received information and information received from the candidate vehicle most recently allocated a place in said sequence;
a selector arranged in operation to select one of said candidate vehicles based on said attributed values; and
an allocator arranged in operation to allocate said selected candidate vehicle the next place in said sequence.

According to a fifth aspect of the present invention there is provided a digital data carrier carrying a program of instructions executable by processing apparatus to perform the method steps as set out in the first aspect of the present invention.

Embodiments of the present invention will now be described, by way of example only, with reference to the accompanying drawings, wherein like reference numerals refer to like parts, and in which:

FIG. 1 shows a table summarising the delays that must be maintained between successive landings of aircraft;

FIG. 2 illustrates aircraft approaching a destination airfield;

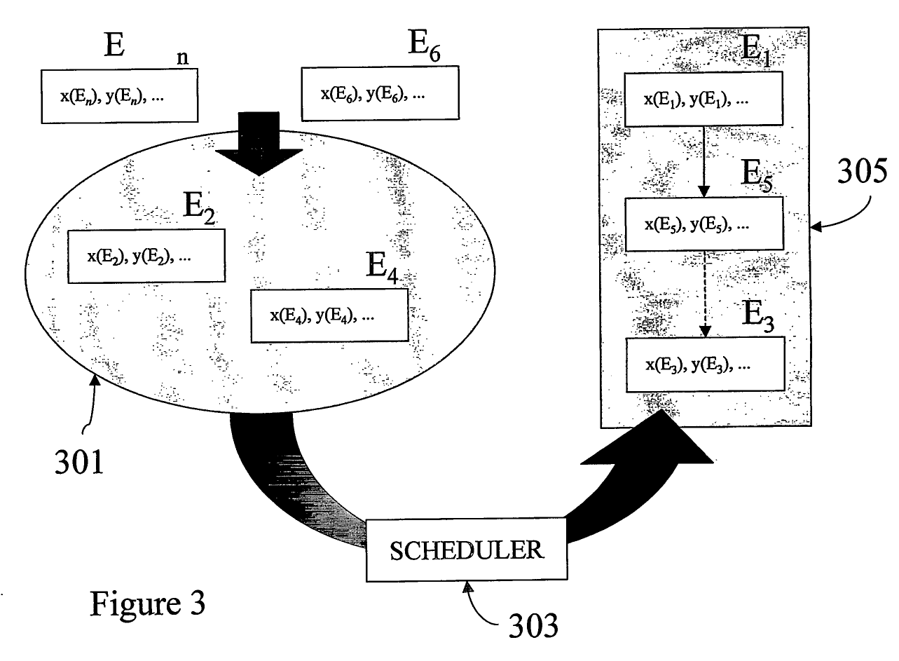

FIG. 3 illustrates a schematic view of the software used to implement an embodiment the present invention;

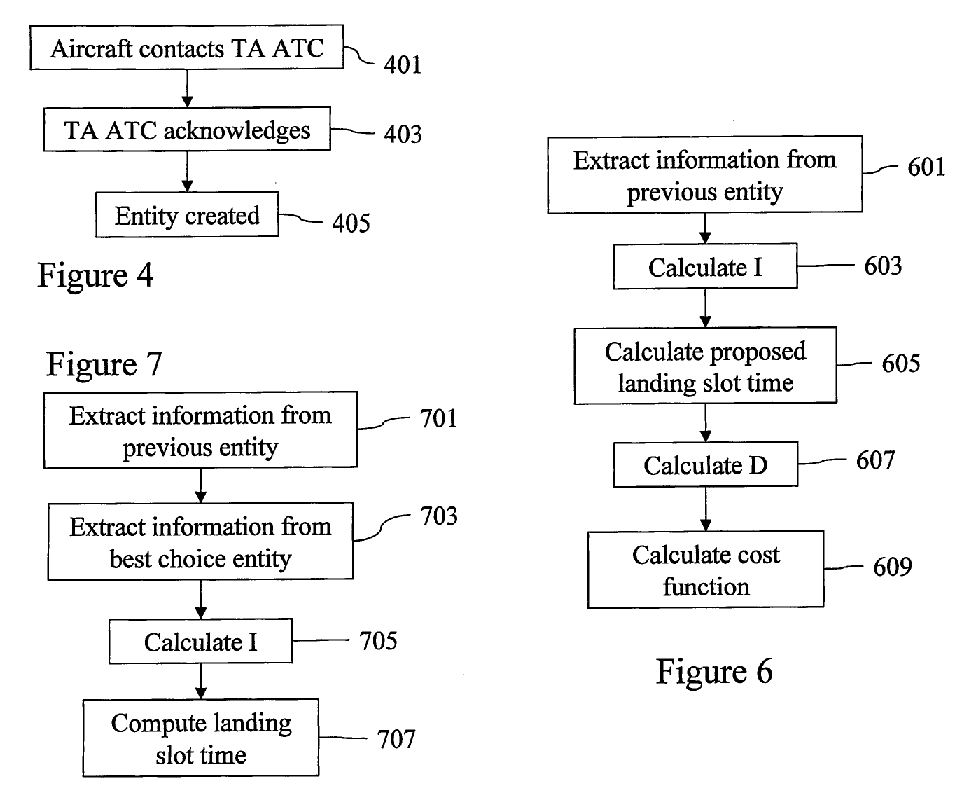

FIG. 4 is a flow diagram illustrating the first stages of an aircraft sequencing process;

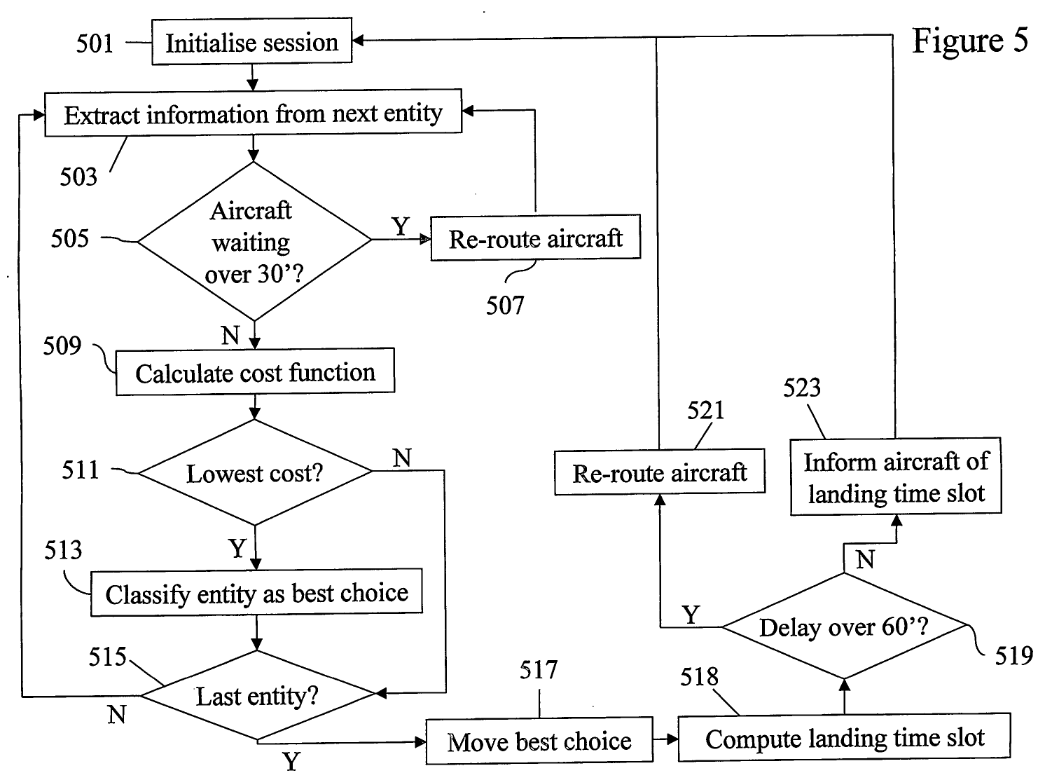

FIG. 5 is a flow diagram illustrating the remaining stages of an aircraft sequencing process;

FIG. 6 is a flow diagram illustrating the calculation of a cost function in accordance with an embodiment of the present invention;

FIG. 7 is a flow diagram illustrating the computation of a landing time slot in accordance with an embodiment of the present invention.

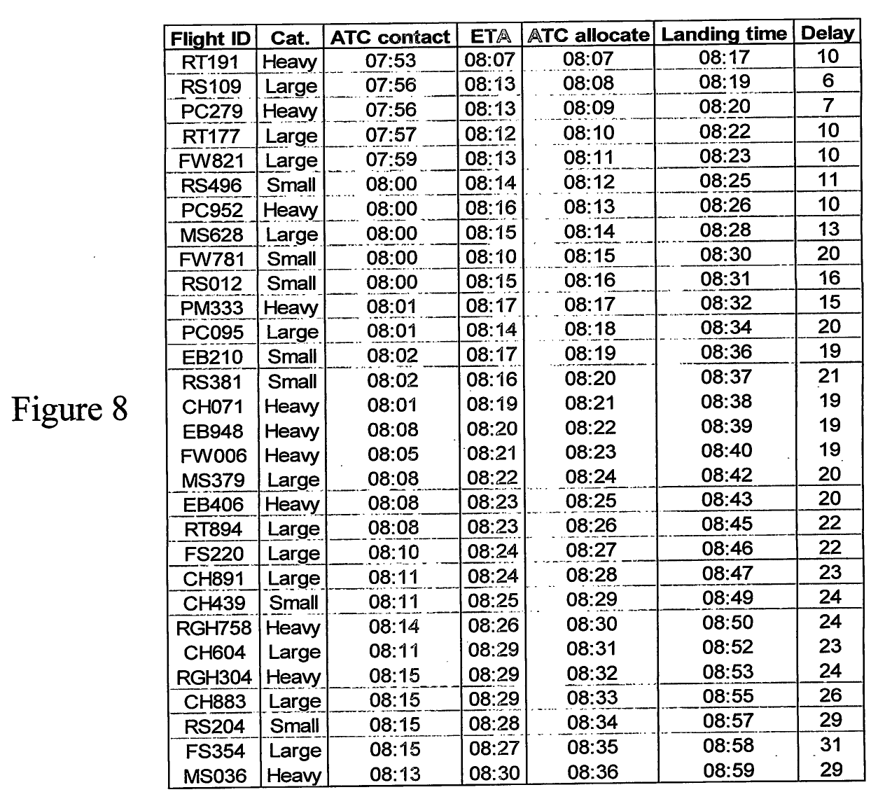

FIG. 8 is a table showing the results of sequencing aircraft on a “first come, first served” basis;

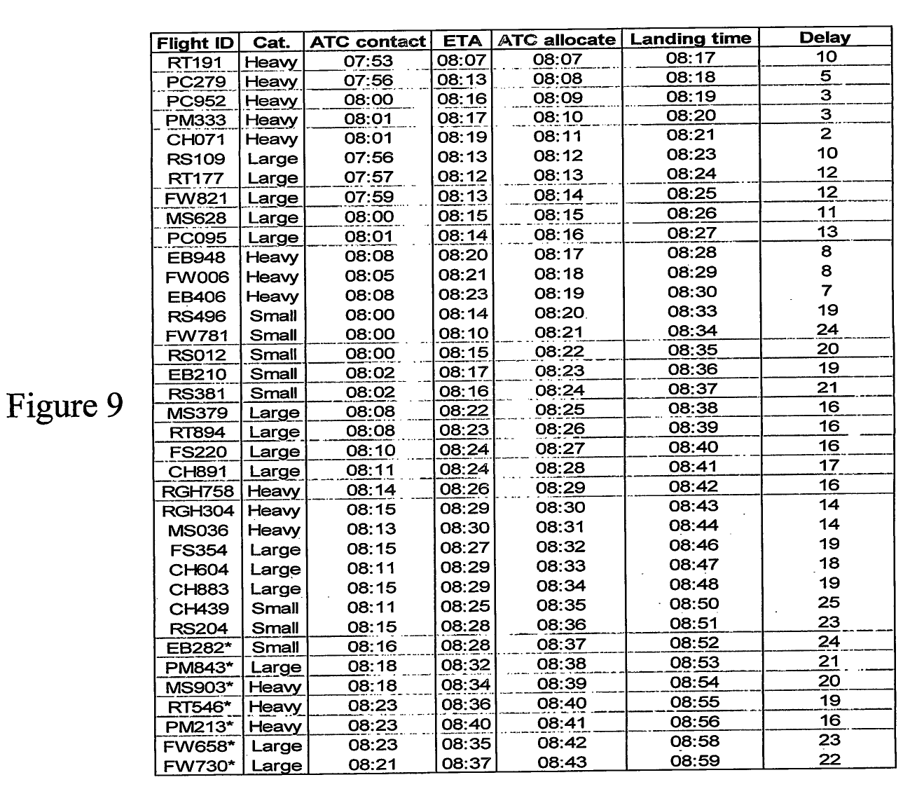

FIG. 9 is a table showing the results of sequencing aircraft in accordance with an embodiment of the present invention;

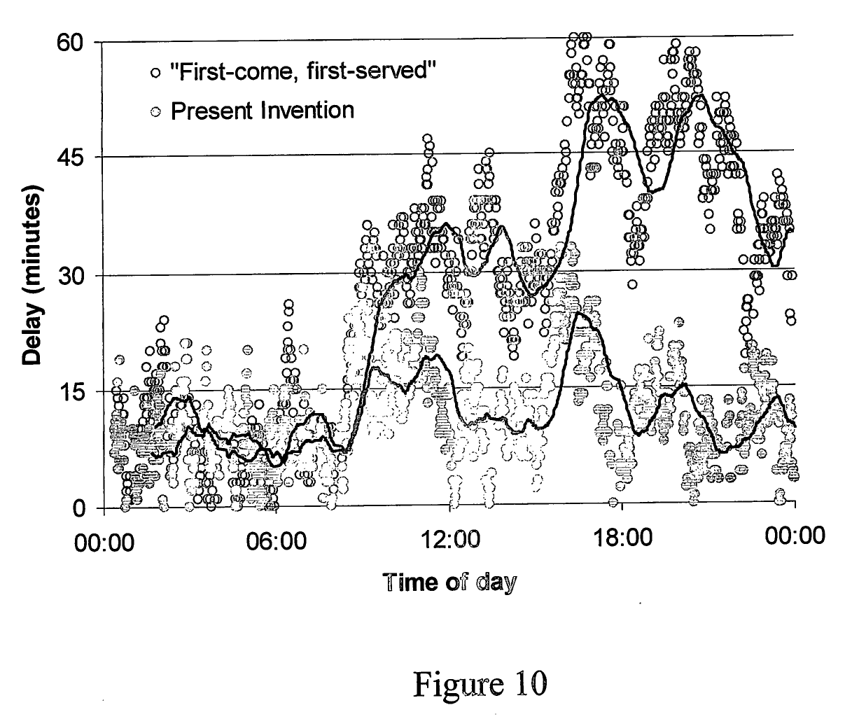

FIG. 10 is a graph showing a comparison in delays suffered by aircraft sequenced on a “first come, first served” basis and delays suffered by aircraft sequenced in accordance with an embodiment of the present invention.

In reference to FIG. 2, a plurality of aircraft 201 are shown approaching a destination airfield within a terminal area under the control of terminal area ATC 203. In order to request a landing time slot at the destination airfield, each of the aircraft 201 must contact terminal area ATC 203 upon entering the terminal area. The aircraft arrive in the terminal area in an unpredictable fashion, i.e. in a random order.

A computer 205 within terminal area ATC 203 operates under the control of software executable to carry out an aircraft sequence selecting process. As will be understood by those skilled in the art, any or all of the software used to implement the invention can be contained on various transmission and/or storage media such as floppy disk, CD-ROM or magnetic tape so that it can be loaded onto the computer or could be downloaded over a computer network using a suitable transmission medium.

Referring to FIG. 3, the software loaded onto computer 205 operates by attributing and/or revising the priorities of entities (E₁, E₂, E₃, . . . , En) within a dynamic set 301. Associated with each entity (Eₙ) is a collection of real-time variables [x(Eₙ), y(Eₙ)]. The software further includes a scheduler 303 which operates in accordance with an optimisation algorithm in order to update the priority of the entities stored in the dynamic set 301 and move them to a static set 305. Each entity represents a single aircraft arriving into the terminal area. Aircraft wait to be allocated a landing time slot in a waiting/holding stack represented by the dynamic set 301. Using the optimisation algorithm, ATC (represented by the scheduler 303) decides the order of the landing sequence which is represented by the static set 305. Examples of the real time variables associated with each entity are the flight identification number of the aircraft, the size of the aircraft and the estimated time of arrival (ETA) of the aircraft at its destination.

Two further real time variables, Iₙ and Dₙ, are defined per entity for use in the algorithm by the scheduler. Iₙ is the interval to the aircraft represented by the latest entity in the static set 305 should the aircraft represented by entity Eₙ be allocated the next landing slot. (It will be remembered that this was described above in relation to FIG. 1.) Dₙ is the delay of the aircraft represented by entity Eₙ when compared with the aircraft's ETA should the aircraft represented by entity Eₙ be allocated the next landing slot.

The two variables, Iₙ and Dₙ, are combined into a cost function f(I,D) which represents the associated ‘cost’ of allocating the next available landing time slot to the aircraft represented by the entity Eₙ. The relative weights of the two variables, Iₙ and Dₙ, in the cost function are adjustable and are defined as the value of two exponents, α and β. The cost function f(Iₙ,Dₙ) is shown in full in equation [1] below:

$$f ( {I}_{n} , {D}_{n} ) = \frac{{I}_{n}^{α}}{{D}_{n}^{β}} \qquad [ 1 ]$$

The cost of selecting one entity from the dynamic set and transferring it to the static set (i.e. allocating the next available timeslot to an aircraft represented by entity Eₙ) is directly proportional to the interval, Iₙ raised to the power α and inversely proportional to the delay, Dₙ raised to the power β. A low interval and a high delay will decrease the cost of selecting a particular entity and hence decrease the cost of allocating a landing time slot to the represented aircraft. The longer an aircraft has already been waiting to be allocated a time slot, the more likely it becomes that it is allocated the next available time slot. However, all things being equal (i.e. all aircraft having similar delays), the aircraft with the shortest interval will be selected. This is best for maximising throughput of aircraft, reducing the chance of a long queue of waiting aircraft and therefore benefiting both the airfield and the aircraft.

Increasing α increases the weight of the interval Iₙ at the expense of the delay Dₙ. This typically results in minimal intervals between successive aircraft. On the other hand, increasing β increases the weight of the delay Dₙ at the expense of the interval Iₙ which typically results in reduced delays and hence reduced waiting times for incoming aircraft.

In preferred embodiments, the values of α and β are set to α=1.0 and β=2.0. However, it is possible to modify the values of α and/or β to reflect changing priorities. Different aircraft may have different priorities due to, for example, an emergency situation on board the aircraft, the amount of fuel the aircraft is carrying, the total duration of the aircraft's journey, the nature of the cargo and/or the passengers onboard the aircraft etc. As a result, what is considered to be an ‘acceptable delay’ may vary accordingly.

Moreover, other variables and/or parameters could be added to equation [1] to account for other factors not included in the preferred embodiment, for example, the intrinsic priority of the aircraft, the current fuel consumption and/or fuel load of the aircraft, current atmospheric conditions, weather forecast etc. This would only modify the output variable returned by the cost function which is used as a decision basis by the scheduler.

In preferred embodiments, the decision as to which entity should be moved from the dynamic set to the static set and hence which aircraft should be allocated the next available landing time slot is made deterministically, that is, the entity with the lowest cost is moved.

Referring now to FIG. 4, on entering the terminal area, an approaching aircraft 201 contacts terminal area ATC 203 (step 401) via radio communication with a request for a landing time slot. This is assumed to take place anytime between ten and twenty minutes before the estimated time of arrival (ETA) of the aircraft at its destination. This initial contact message contains information such as a flight identification number of the aircraft, the size of the aircraft and the ETA of the aircraft. Upon receiving the contact message, terminal area ATC 203 acknowledges the message by sending a message back to the requesting aircraft 201 (step 403) which includes an order to wait in the waiting/holding stack. At the same time, an entity representing the requesting aircraft 201 is created by terminal area ATC 203 and added to the dynamic set 301 (step 405). This is achieved, for example, by inputting the relevant information onto computer 205 via a keyboard (or other such input device) attached to the computer 205. In other embodiments, the information could be entered automatically into computer 205 via a datalink established between the requesting aircraft and terminal area ATC 203. Associated with that entity are the real time variables representing the information sent by the aircraft to terminal area ATC 203. The process described above in relation to FIG. 4 is repeated whenever an aircraft 201 enters the terminal area. Several aircraft 201 may enter the terminal area every minute contacting terminal area ATC 203 with a request for a landing time slot. This results in several entities being created and added to the dynamic set.

Referring to FIG. 5, the operation of the scheduler will now be described in further detail. Firstly, a new session of the scheduler is initialised (step 501). A new session is begun for each landing time slot that is to be allocated by the scheduler. In preferred embodiments the scheduler is run once every minute although in other embodiments more or less sessions per minute may be more suitable.

The scheduler then extracts information (step 503) for the next entity representing an aircraft that has contacted terminal area ATC 203. The information extracted is that which the aircraft sent to terminal area ATC 203 in its initial contact message (FIG. 4, step 401). The scheduler then checks (step 505) whether or not the entity currently being processed has been waiting in the dynamic set for over a specified period of time, e.g. thirty minutes. (It will be realised that this corresponds to an aircraft waiting in the waiting/holding stack for more than thirty minutes.) If this check yields a positive result then terminal area ATC 203 contacts the aircraft represented by this entity in order to re-direct it to another airfield (step 507) and the representative entity is removed from the dynamic set. If the check is negative then the scheduler continues to calculate the cost function for this entity (step 509). The calculation of the cost function will be described in more detail below.

The scheduler then checks (step 511) whether or not the cost function just calculated is the lowest so far calculated in this session. If it is the lowest so far calculated then this entity is temporarily classified as the best choice entity (step 513) until a time when the cost function of another entity is lower. Having calculated the cost function for the first entity in the current session, the scheduler then checks (step 515) whether or not cost functions for all the entities currently within the dynamic set have been calculated. If the result of this check is negative then steps 503 to 515 are repeated. If cost functions have been calculated for all the entities currently within the dynamic set then the entity that ends up classified as the best choice entity is moved from the dynamic set to the static set (step 517) and the scheduler computes (step 518) the next available landing time slot to allocate to the aircraft represented by the best choice entity. The computation of the landing time slot will be described in more detail below.

Having computed the landing time slot to be allocated to the aircraft represented by the best choice entity, the scheduler checks whether or not the delay associated with that aircraft (i.e. the difference between its allocated landing time slot and its ETA) is longer than a specified time period, e.g. sixty minutes. If the result of this check is positive then terminal area ATC 203 contacts the aircraft in order to re-direct it to another airfield (step 521) after which time a new session of the scheduler is started. If the result of the check is negative then terminal area ATC 203 contacts the aircraft and informs it of its allocated landing time slot (step 523) at which time a new session of the scheduler is started.

With reference to FIG. 6, the calculation of the cost function (carried out in step 509) will now be explained in more detail. The scheduler first extracts information (step 601) from the last entity that was moved from the dynamic set to the static set. It will be realised that this entity represents the most recent aircraft to be allocated a landing time slot. The information extracted includes the size of the most recent aircraft and the landing time slot allocated to it. Using this information and the size of the aircraft represented by the entity currently being processed (which it will be remembered was extracted in step 503), the scheduler then computes (step 603) what the interval (I) between these two aircraft would have to be if the aircraft represented by the entity currently being processed were allocated the next landing time slot. In the present embodiment, the intervals between successive aircraft are those described above in relation to the table in FIG. 1, although otherwise defined intervals are also possible. The scheduler can then add this interval to the landing time slot allocated to the most recent aircraft to compute (step 605) a proposed landing time slot for the aircraft represented by the entity currently being processed. The scheduler can then compute the delay (D) (step 607) that the aircraft represented by the entity currently being processed would suffer if allocated this landing time slot by comparing it with the aircraft's ETA. Finally the scheduler can use the interval I and delay D to compute the cost function (step 609) of the entity currently being processed.

With reference to FIG. 7, the computation of the landing time slot (carried out in step 518) will now be described in more detail. The scheduler first extracts information (step 701) from the last entity that was moved from the dynamic set to the static set. It will be realised that this entity represents the most recent aircraft to be allocated a landing time slot. The information extracted includes the size of the most recent aircraft and the landing time slot allocated to it. Using this information and the size of the aircraft represented by the best choice entity extracted by the scheduler in step 703, the scheduler then computes (step 705) what the interval (I) between these two aircraft has to be based on the intervals defined above in relation to the table in FIG. 1. Finally, the scheduler adds this interval to the landing time slot allocated to the most recent aircraft to compute (step 707) the landing time slot for the aircraft represented by the best choice entity.

It will be realised that in calculating the cst function for the best choice entity (in step 509), a proposed landing time slot for the aircraft represented by the best choice entity is calculated (in step 605). Hence in alternative embodiments, this information could be temporarily stored by the computer 205 and used by terminal area ATC 203 when it contacts the aircraft and informs it of its allocated landing time a lot (in step 523).

FIG. 8 illustrates the landing sequence for the period 08:17 to 08:59 made on a “first come, first served” basis. FIG. 9 illustrates the landing sequence for the same period and for an identical traffic pattern (same aircraft, same order of arrival) computed in accordance with the present invention.

The tables in both FIGS. 8 and 9 are sorted by “Landing Time” which refers to the time the aircraft lands at its destination. “Flight ID” refers to the flight identification number of the aircraft, “Cat.” refers to the size category of the aircraft, “ATC contact” refers to the time that the aircraft sends its initial contact message to terminal area ATC 203 on entering the terminal area, “ETA” refers to the aircraft's estimated time of arrival at its destination, “ATC allocate” refers to the time when terminal area ATC 203 contacts the aircraft with details of its allocated landing time slot and “Delay” refers to the difference in time between the aircraft's ETA and its actual landing time.

The shaded rows in the table 9 indicate aircraft that contacted terminal area ATC 203 earlier than some of the preceding aircraft but were allocated landing time slots later than these predecessors. (This series of events can occur when the landing sequence is decided on a “first come, first served” basis but only when an aircraft that contacts terminal area ATC 203 has a later ETA than some of the following aircraft. This is indicated by the shaded rows in table 8.)

Referring to FIG. 8, thirty aircraft land in the forty-two minute period between 08:17 and 08:59. The average interval between them is one minute, twenty-five seconds and the average delay suffered by each aircraft is eighteen minutes, forty-four seconds. Referring to FIG. 9, thirty-seven aircraft land in the same forty-two minute period. The average interval between them is now only one minute, ten seconds and the average delay suffered by each aircraft has fallen to fifteen minutes, sixteen seconds. This represents a 23.3% increase in capacity at the destination, a 18.5% reduction in the average delay suffered by arriving aircraft and a 17.4% reduction in the average interval between successive aircraft landings. This translates into a large improvement in quality of service for the airlines operating the aircraft, including a substantial reduction in fuel consumption and an increase in revenue for airfields due to the increase in capacity.

The graph in FIG. 10 summarises the comparison. It is a plot of the delay suffered by aircraft against the time of day at which they land at their destination. By noon, nearly all flights are delayed by at least thirty minutes and the situation continues to deteriorate since in the absence of any optimisation, the extra air traffic cannot be absorbed and the waiting/holding queue can only continue to grow. In contrast, the delay suffered by flights sequenced in accordance with the present invention remains fairly constant throughout the day. By the end of the day, three aircraft sequenced on a “first come, first served” basis had to be re-routed to another destination because they suffered delays exceeding the maximum allowed delay (one hour in this case). The average delay suffered by aircraft was above thirty minutes compared with less than ten minutes for aircraft sequenced in accordance with the present invention.

Although in the above described embodiment the decision as to which entity should be moved from the dynamic set to the static set and hence which aircraft should be allocated the next available landing time slot is made deterministically, it is also possible to make the decision probabilistically on the basis of a function similar to:

$${C}_{x} = \frac{f ( {I}_{x} , {D}_{x} )}{{\sum }_{i = 1}^{N} f ( {I}_{i} , {D}_{i} )}$$

$${P}_{x} = \frac{1 - {C}_{x}}{{\sum }_{i = 1}^{N} 1 - {C}_{i}}$$

where N is the number of entities currently waiting in the dynamic set, Cₓ is the relative cost of selecting entity x and Pₓ is the probability that entity x is chosen.

Although the above embodiment was described in relation to the landing sequence of aircraft, it will be apparent that the present invention is just as applicable to the sequencing of any vehicles in a situation where those vehicles disturb the environment behind them as they proceed. One example of such a situation is ships/boats which leave a wake behind them.

The present invention successfully optimises sequences of vehicles. Test results suggest that sequencing aircraft about to land in accordance with the present invention leads to an increase in capacity at airfields (since aircraft can land more often) and an improvement to the quality of service provided by airlines operating those aircraft (since the delays suffered by aircraft is reduced). These two objectives were previously thought to be incompatible.

1. A method of sequencing a plurality of candidate vehicles, wherein each candidate vehicle in said plurality of candidate vehicles is a candidate to be allocated the next place in a sequence, said method comprising the steps of:
(i) receiving information pertaining to one of said candidate vehicles;
(ii) calculating a value to be attributed to said candidate vehicle on the basis of said received information and information received from the candidate vehicle most recently allocated a place in said sequence;
(iii) repeating steps (i) and (ii) for each of said candidate vehicles;
(iv) selecting one of said candidate vehicles based on said attributed values; and
(v) allocating said selected candidate vehicle the next place in said sequence.

2. A method as claimed in claim 1, wherein said vehicles are aircraft.

3. A method as claimed in claim 2, wherein said sequence is the landing sequence.

4. A method as claimed in claim 1, wherein said received information is received from the candidate vehicle to which said received information pertains.

5. A method as claimed in claim 1, wherein said received information includes information relating to the size of the candidate vehicle to which said information pertains.

6. A method as claimed in claim 1, wherein said value is representative of the spacing that would have to be maintained between the candidate vehicle and the candidate vehicle most recently allocated a place in said sequence if said candidate vehicle were allocated the next place in the sequence.

7. A method as claimed in claim 1, wherein said value is representative of the delay that would be experienced by said candidate vehicle if said candidate vehicle was allocated the next place in the sequence.

8. A method of operating a sequencing apparatus to sequence a plurality of candidate vehicles, wherein each candidate vehicle in said plurality of candidate vehicles is a candidate to be allocated the next place in a sequence, said method comprising the steps of:
(i) receiving information pertaining to one of said candidate vehicles;
(ii) calculating a value to be attributed to said candidate vehicle on the basis of said received information and information received from the candidate vehicle most recently allocated a place in said sequence;
(iii) repeating steps (i) and (ii) for each of said candidate vehicles;
(iv) selecting one of said candidate vehicles based on said attributed values; and
(v) allocating said selected candidate vehicle the next place in said sequence.

9. A method as claimed in claim 8 further comprising the step of:
(vi) sending details of the next place in said sequence to said selected candidate vehicle.

10. A method as claimed in claim 8, wherein said vehicles are aircraft.

11. A method as claimed in claim 10, wherein said sequence is the landing sequence.

12. Sequencing apparatus arranged in operation to sequence a plurality of candidate vehicles, wherein each candidate vehicle in said plurality of candidate vehicles is a candidate to be allocated the next place in a sequence, said data processing apparatus comprising:
receiving means for receiving information pertaining to one of said candidate vehicles;
calculating means for calculating a value to be attributed to said candidate vehicles on the basis of said received information and information received from the candidate vehicle most recently allocated a place in said sequence;
selecting means for selecting one of said candidate vehicles based on said attributed values; and
allocating means for allocating said selected candidate vehicle the next place in said sequence.

13. Sequencing apparatus arranged in operation to sequence a plurality of candidate vehicles, wherein each candidate vehicle in said plurality of candidate vehicles is a candidate to be allocated the next place in a sequence, said data processing apparatus comprising:
a receiver arranged in operation to receive information pertaining to one of said candidate vehicles;
a calculator arranged in operation to calculate a value to be attributed to said candidate vehicles on the basis of said received information and information received from the candidate vehicle most recently allocated a place in said sequence;
a selector arranged in operation to select one of said candidate vehicles based on said attributed values; and
an allocator arranged in operation to allocate said selected candidate vehicle the next place in said sequence.

14. Sequencing apparatus according to claim 13, wherein said vehicles are aircraft.1

15. Sequencing apparatus according to claim 14, wherein said sequence is the landing sequence.

16. A digital data carrier carrying a program of instructions executable by processing apparatus to perform the method steps as set out in claim 1.
